(19) United States
(12) Patent Application Publication
(10) Pub. No.: US 2015/0134143 A1
(43) Pub. Date: May 14, 2015

(54) Novel tracking system using unmanned aerial vehicles

(71) Applicant: Jim Willenborg, San Francisco, CA (US)

(72) Inventor: Jim Willenborg, San Francisco, CA (US)

(21) Appl. No.: 14/121,686

(22) Filed: Oct. 6, 2014

Related U.S. Application Data
(60) Provisional application No. 61/886,974, filed on Oct. 4, 2013.

(51) Int. Cl. B64C 39/02; G05D 1/00; G05D 1/04

(52) U.S. Cl. CPC B64C 39/024; G05D 1/042; G05D 1/0033; B64C 2201/12; B64C 2201/146
USPC 701/2

(57) ABSTRACT

The present disclosure relates to systems and methods of tracking persons and objects and capturing video, still images and other data in real time of the same. The present disclosure includes an unmanned aerial vehicle (e.g., UAV) which follows a trackable system coupled to an object or on individual's person. The UAV may have a camera component which may record video, still images and other data (position, speed, acceleration, cadence, etc.) of the trackable system and items in close proximity thereto. Advantageously, the UAV may transmit video feeds and still images to a monitoring station or device such that security personnel and other persons of interest can respond timely to unplanned incidents and emergencies. In one or more implementations, a network of UAVs may fly alongside each other to capture video of multiple targets without causing collisions.

### FIELD

The present disclosure relates to systems and methods of tracking moving persons and objects, capturing video, still images, and other data, such as, but not limited to, altitude, speed, acceleration, cadence, and the like.

### BACKGROUND

Conventional systems, such as radio frequency identification (RFID) tags have enabled location capability of persons and objects. For example, within a manufacturing environment, a RFID tag may be attached to a production part to locate the part along an assembly line. However, most conventional systems do not send position data to a remote tracking device to reposition the tracking device but are limited to reporting that a tracked device is in a specific area.

Many conventional systems also lack the ability to capture and relay video and other data feeds real time and to use that data to track and reposition a tracking device. Unfortunately, this inability limits time responses to disruptions and dangerous incidents which may limit video and still images to fixed positions.

Accordingly, a system to visually track and capture video, still images, and other data of persons and objects in real time is needed. The present disclosure addresses this need.

### SUMMARY OF THE DISCLOSURE

The following summary is included in order to provide a basic understanding of some aspects and features of the present disclosure. This summary is not an extensive overview of the disclosure and as such it is not intended to particularly identify key or critical elements of the disclosure or to delineate the scope of the disclosure. Its sole purpose is to present some concepts of the disclosure in a simplified form as a prelude to the more detailed description that is presented below.

The present disclosure relates to systems and methods of tracking moving persons and objects, capturing video, still images, and other data, such as, but not limited to, altitude, speed, acceleration, cadence, and the like. The present disclosure includes an unmanned aerial vehicle (e.g., drone) which follows a trackable system which may be coupled to an object (e.g., board mount or handlebar mount) or on an individual's person. An unmanned aerial vehicle (UAV) consistent with the present disclosure may have a camera, sensor device, data receiver and transmitter. The unmanned aerial vehicle may transmit video feeds and still images to a monitoring station so that safety personnel can respond timely to emergency and safety incidents, or simply record video, still images, or other data in real time to broadcast or investigate for later analysis.

In addition, a plurality of unmanned aerial vehicles may fly alongside each other to capture video of multiple targets without collisions inter-UAV communication or by implementing a system in which each UAV follows instructions sent from a central monitoring station to the network of unmanned aerial vehicles.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is a schematic diagram of an unmanned aerial vehicle in position to capture video, still images and other data of a surfer riding a surfboard.

FIG. 2A illustrates an exploded front view of a disassembled trackable system.

FIG. 2B illustrates an exploded back view of the disassembled trackable system.

FIG. 3 is a schematic diagram of an unmanned aerial vehicle in position to capture video, still images, and other data of an adolescent walking alone in public.

FIG. 4 is a simplified schematic diagram of an unmanned aerial vehicle in position to capture video, still images, and other data of a security vehicle.

FIG. 5 is a simplified schematic diagram of a network of unmanned aerial vehicles in position to capture video, still images and other data of sprinters competing at a track meet.

FIG. 6 is a simplified schematic diagram of a network of unmanned aerial vehicles in position to capture video, still images, and other data of swimmers competing in a swim meet.

FIG. 7 is a simplified schematic diagram of an unmanned aerial vehicle in position to capture video, still images, and other data of a biker.

FIG. 8 is a simplified schematic diagram of an unmanned aerial vehicle changing its vertical position while following and capturing video, still images, and other data of a biker.

FIG. 9A is a simplified schematic diagram of an unmanned aerial vehicle that is out of signal with a trackable system in possession of a biker previously followed by the UAV.

FIG. 9B is a simplified schematic diagram of an unmanned aerial vehicle that is heading to a previously programmed home base.

FIG. 10 is a simplified schematic diagram of an unmanned aerial vehicle hovering above a biker performing maintenance on the biker's bike.

FIG. 11 is a simplified schematic diagram of a trackable system consistent with embodiments of the present disclosure.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

It must be noted that as used herein and in the claims, the singular forms “a,” and “the” include plural referents unless the context clearly dictates otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

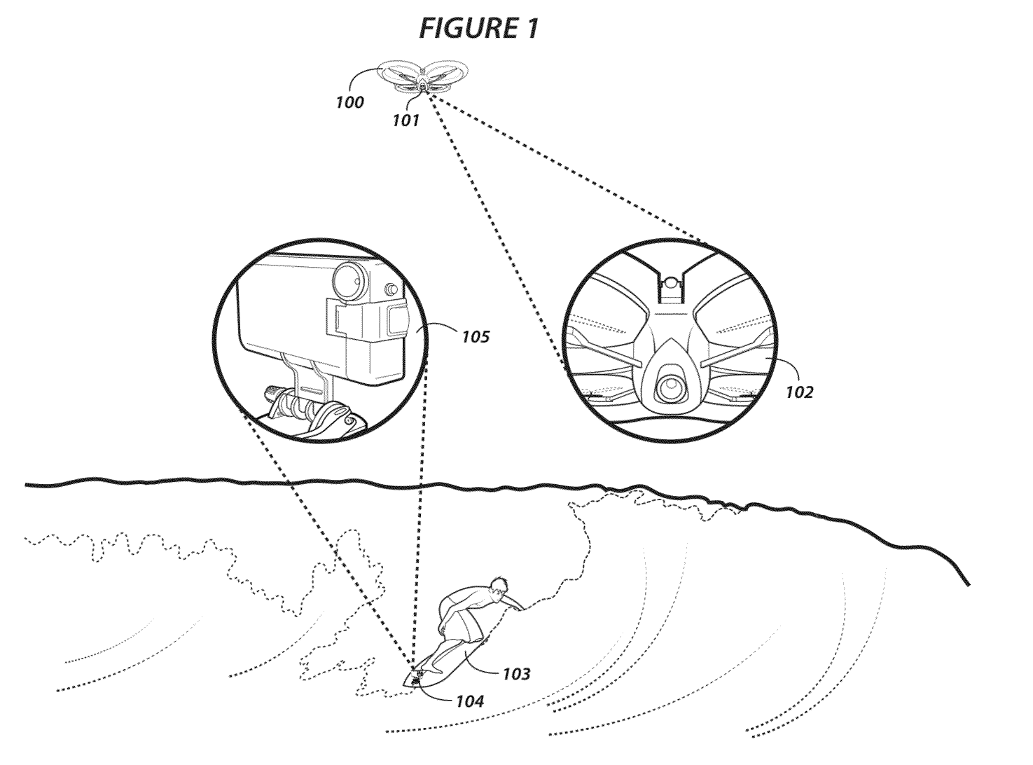

FIG. 1 is a schematic diagram of an unmanned aerial vehicle 100 in position to capture video, still images, and other data of a surfer riding on a surfboard. The UAV 100 displayed in the figure has the ability to fly in the sky and continuously maintain a position (e.g., in front, behind, aside, etc.) relative to the tracked object. Advantageously, a UAV 100 consistent with the present disclosure is capable of following an individual or object, such as a vehicle, by following a trackable system 104 coupled thereto which will be described in more detail below. As such, UAV 100 may be referred herein as a tracking device.

UAV 100 has the ability to capture and record video and transmit and receive data to and from remote devices for alerts or positioning purposes. UAV 100 may transmit and receive data from a smartphone, tracking device transmitter, controller, information service (e.g., monitoring station), or from operators over the internet. A camera 101 component may capture video, still images, and other data which may be stored in a memory compartment (not shown) of the UAV 100.

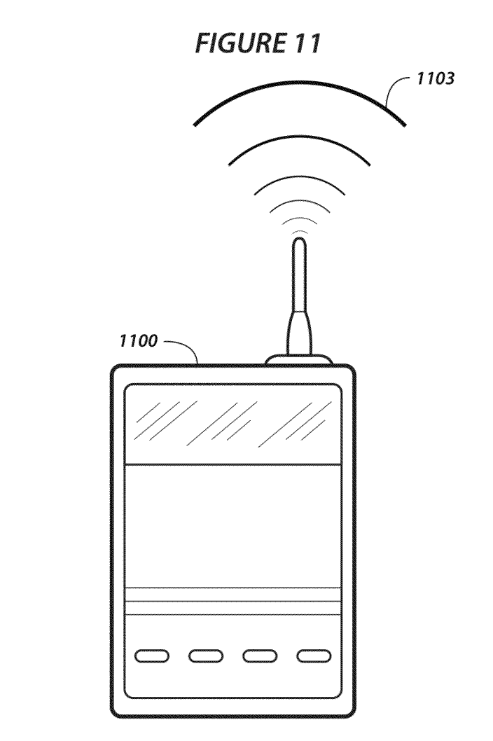

FIG. 11 illustrates a simplified schematic diagram of a trackable system 1100 consistent with embodiments of the present disclosure. Trackable system 1100 includes a transmitting device, such as a smartphone, with GPS capability that sends signals to a tracking device and may include a sensor device, data receiver, and transmitter (along with power subsystems known in the art). A trackable system 1100 may store and transmit video, cadence, location, acceleration, and other pertinent data to a tracking device or monitoring station. Any one of the aforementioned metrics may initiate filming, sending alerts to announcers and safety personnel (e.g., medical assistance) to the site.

In some embodiments, trackable system 1100 is communicatively coupled (e.g., wirelessly 1103) to the UAV which may also transmit and receive data to and from a monitoring or control station. The trackable system 1100 may include global positioning system (GPS) components which aids the system transmit its position to a tracking device or monitoring station and may be used to collect acceleration, speed, and altitude data. In some embodiments, the GPS component may transmit its position to a tracking device or system.

Referring back to FIG. 1, aerial positions above trackable system 104 may be configured to fly parallel or perpendicular to the latitudinal or longitudinal GPS location of the trackable system's 104 position. For example, trackable system 104 may transmit data, such as its GPS location, to a monitoring station which may in turn transmit instructions, data, and positioning commands to the UAV 100. Trackable system 104 may include a Point of View (POV) video mounting system which includes a smartphone device coupled to the surfboard 103 (see close up view 105).

UAV 100 may be synced and configured to follow trackable system 104 at a predetermined height above the ground. UAV may also be configured to follow trackable system 104 in front, back, side or other position (e.g., according to a preprogrammed offset) relative to the trackable system 104. In some embodiments, the height that the UAV 100 flies above the trackable system 104 is the sum of a preconfigured distance (e.g., 10 feet) and the height that the trackable system 104 is above sea level (e.g., 280.2, M).

The preconfigured height that the UAV 100 flies above the trackable system 104 may be set according to the capability of the UAV's camera 101 to capture and record video feeds and still images. In addition, the preconfigured height of the UAV above the trackable system 104 may also be set according to the UAV's 100 ability to communicate with the trackable system 104 (e.g., receive GPS data from the trackable system). Moreover, the preconfigured height that the UAV 100 flies above the trackable system 104 may be configured according to the signal intensity of the trackable system 104 or the ability of the UAV 100 to receive communications from the system 104.

Close-up view 102 shows a larger image of an exemplary camera 101 component of UAV 100. Camera 101 may include various features such as, but not limited to, digital-image stabilization. Furthermore, camera 101 or the camera on the tracked device, if any, may include a lens-distortion correction feature and may take megapixel stills with photo burst and time lapse options. Camera 101 may have the capability to take stills while recording video and may also have a micro HDMI output for convenient video playback and a microSD slot such that several gigabytes of data can be stored in a memory card. For example, camera 101 may include a 64 GB microSD card which may hold over seven hours of 1080p video.

In some embodiments, UAV 100 and trackable system 104 may include components such as an accelerometer, altimeter sensor(s) and components to support wireless communication capabilities for various protocols—cellular, Bluetooth, and WiFi. UAV 100 may connect to one or more WIFI networks and may execute commands issued via mobile applications for iPhone, Android, etc. UAV 100 may also be equipped with specific activity profiles to track the UAV's 100 location, speed, temperature, cadence, position, and elevation while recording.

In FIG. 1, UAV 100 follows a surfer riding waves in the ocean. Advantageously, the UAV 100 may capture, record, and transmit video, still images, and other data as the surfer rides the surfboard 103. For example, during a competition, a live stream of the surfer's performance may be captured and transmitted to television networks so that viewers may view the surface in action. As shown, the surfer may don the trackable system 104 conspicuously or in plain view so long as the device 104 can communicate with the UAV 100. Close-up view 105 shows that the trackable device 104 includes a water-proof casing which encloses a smartphone device that captures the surfer's performance data.

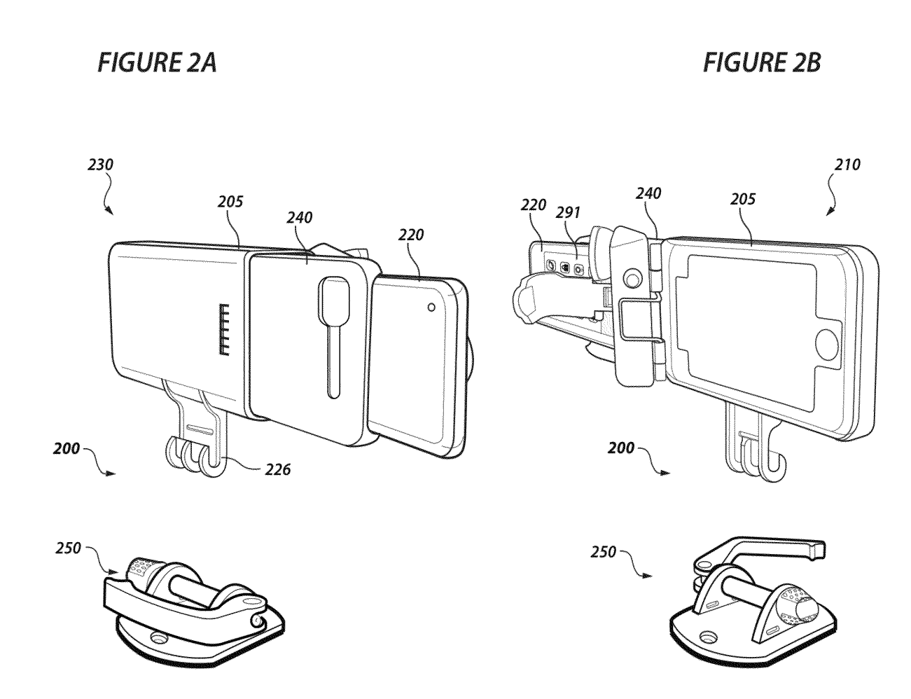

FIG. 2A illustrates an exploded front view of a disassembled trackable system. As shown, trackable system 200 includes a casing assembly 205, smartphone device 220, and mounting assembly 250. Smartphone device 220 includes video, data recording, and display capabilities. For example, smartphone device 220 may be an iPhone® device sold and distributed by Apple Computers. The present disclosure is not limited to any particular device. As such, any device which includes video and/or data recording and communication capabilities is within the spirit and scope of the present disclosure. Smartphone device 220 can display live images, video streams, performance metrics, and other useful information on the device's 200 display. Smartphone device 220 may also record videos at 720p-1080p resolutions and higher as they become available.

FIG. 2B illustrates an exploded back view of the disassembled trackable system 200. With respect to FIG. 2A, FIG. 2B illustrates the front side of casing assembly 205. Accordingly, FIG. 2A and FIG. 2B illustrate different perspective views of an embodiment of a POV video and/or mounting system 200. It should be understood that assembling the components shown in FIG. 2A and FIG. 2B results in a configured trackable system 200.

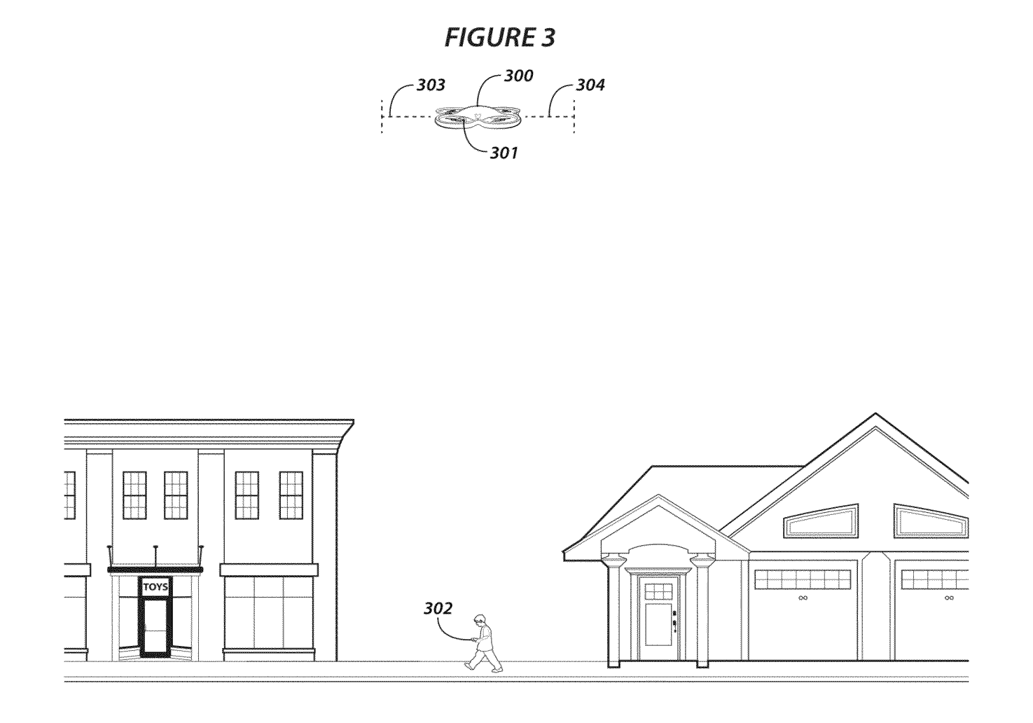

FIG. 3 is a schematic diagram of a UAV 300 in position to capture video, still images and other data of an adolescent walking alone in public. Particularly, the UAV 300 tracks the trackable system 302 on the adolescent's person to transmits video data to the adolescent's parent (e.g., via TV or mobile phone). The trackable system 302 transmits position and other data to the UAV 300 overhead or to a monitoring station that sends positioning instructions to the UAV 300. In addition, a camera 301 component of the UAV 300 is in position to capture video and still objects of the trackable system 302 and other objects proximate thereto.

In addition, the UAV 300 may not be directly above the adolescent due to the delay associated with the time required for the UAV 300 to receive and process the location data from the trackable system 302. In some embodiments, UAV 300 may be configured to fly a predetermined distance ahead of 303 or behind 304 the trackable system 302 to compensate for the time delay.

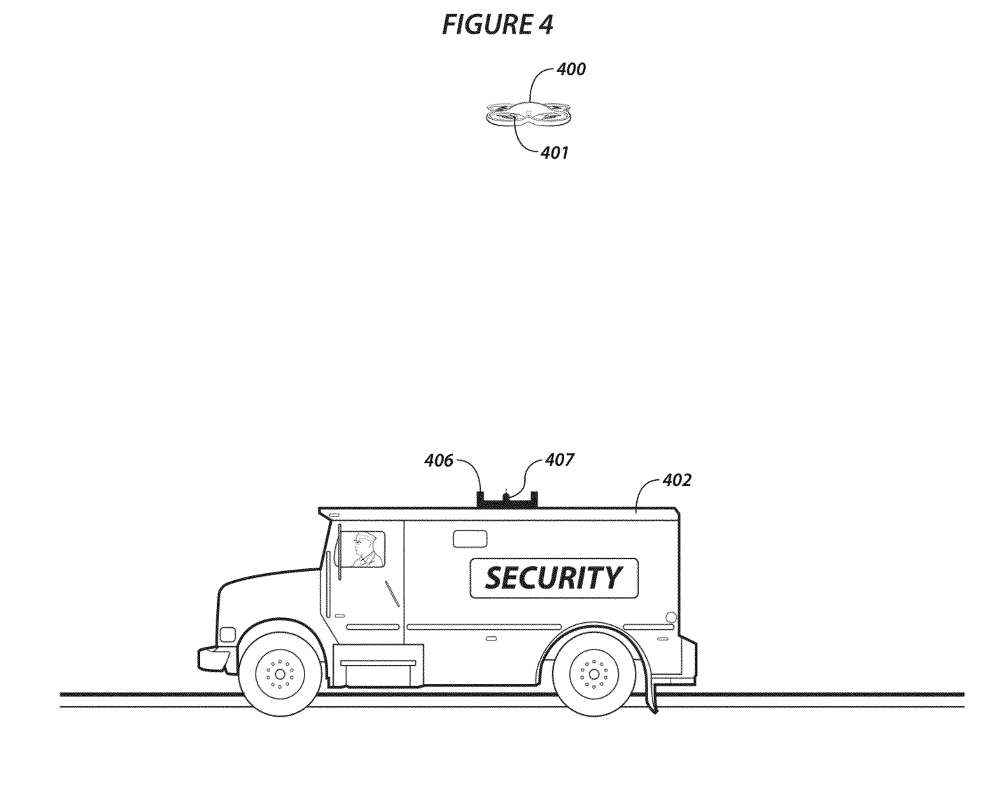

FIG. 4 is a simplified schematic diagram of a UAV 400 in position to capture video, still images, and other data of a security vehicle 402. As shown, UAV 400 follows security vehicle 402 close enough so that camera 401 can capture video feeds of the vehicle and areas proximate thereto. Accordingly, security personnel may monitor the security vehicle 402 at each drop point to timely respond to any unplanned or emergency incidents.

In some embodiments, a docking station 406 is disposed on the top of the security vehicle 402. In this embodiment, the UAV 402 would launch from the docking station 406 when the security vehicle 402 is stationary or upon instruction of the driver. In some embodiments, the trackable system 407 may be removed from the docking station 406 once security personnel (e.g., driver) exits the security vehicle 402. In the event that the driver leaves the security vehicle 402 with the trackable system 407, the UAV 400 follows the driver accordingly. As such, other security personnel stationed at a remote location away from the security vehicle 402 can timely respond to unplanned events and attacks.

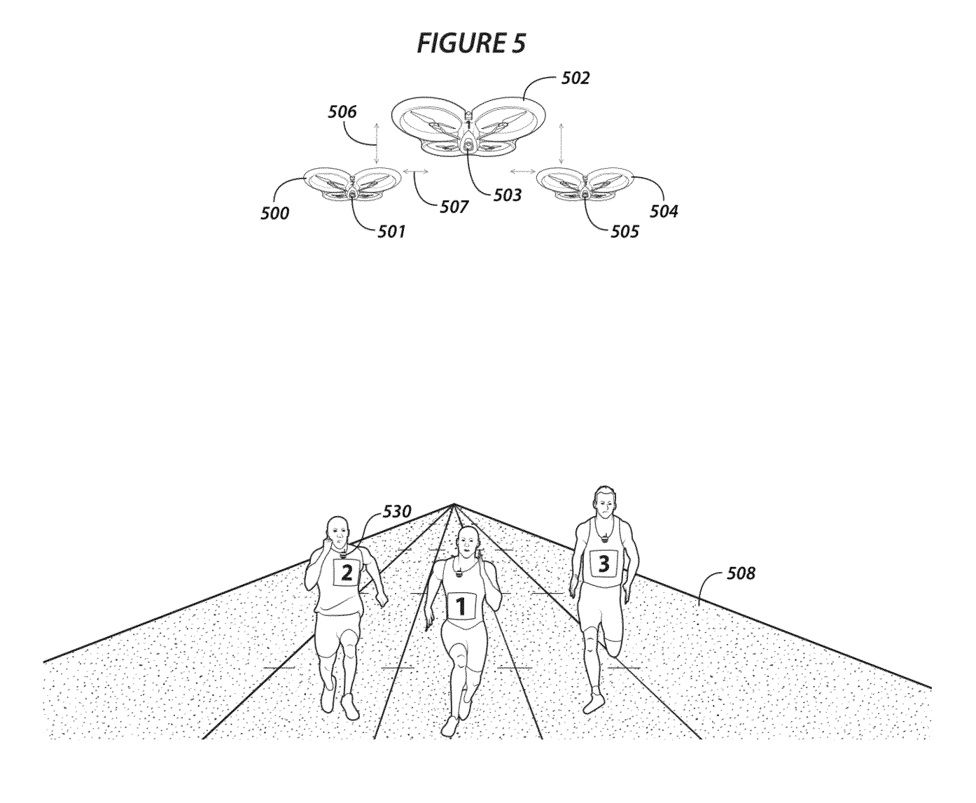

FIG. 5 is a simplified schematic diagram of a network of UAVs 500, 502, 504 in position to capture video, still images, and other data of sprinters competing at a track meet. As shown in the figure, each UAV follows a single sprinter as they race along the track 508. For example, UAV 502 follows the sprinter having the number “1” on his jersey (sprinter #1) whereas UAV 500 follows sprinter #2. Likewise, UAV 504 follows sprinter #3. Advantageously, the camera components 501, 503, 505 of each UAV may capture video feeds and still images of the sprinter during the event. For instance, UAV 502 can capture video feeds, still images, speed metrics, and other relevant data of the sprinters as they race along the track 508.

In the figure, each UAV is at the same height. However, the present disclosure is not so limited and each of the UAVs 500, 502, 504 may be at different heights. Moreover, the position of each UAV 500, 502, 504 may be preset to travel along a specific lane.

If each sprinter runs within their respective lanes, the UAVs 500, 502, 504 should not crash into each other above the track 508. Collision avoidance may be further aided by sending UAV instructions from a UAV control station to keep the UAVs a predetermined distance apart. In alternative embodiments, each UAV can monitor the commands and data (e.g., snooping) sent to the other UAVs and can calculate the UAV's relative position and anticipated relative position with respect to the other UAVs to prevent collisions.

Alternatively, UAVs 500, 502, 504 may be pre-programmed to fly within specified lateral/horizontal barrier(s). For example, each of the UAVs 500, 502, 504 may be configured to stay within a set of horizontal GPS components (e.g., 8150, W and 8155 W). Accordingly, the UAVs 500, 502, 504 will move along the track 508 following the tracking device 530 during the race but will not fly laterally outside of the preset barriers regardless of whether the sprinters traverse outside of their pre-assigned lanes during the race.

In the event that a sprinter traverses outside of the sprinter's pre-assigned lane, the assigned UAV following the sprinter's tracking device 530 may move in other directions other than those which would lead the tracking device 530 to fly outside of the pre-programmed barriers. For example, if the sprinter runs in a diagonal direction (e.g., lateral X and longitudinal Y directions) outside of the sprinter's assigned lane into another sprinter's lane, the device will continue to travel forward (e.g., Y direction) and laterally (e.g., X direction) only until the point when the UAV meets the preset barrier(s). Moreover, the network of UAVs 500, 502, 504 may all be on the same communications network (e.g., WiFi) and may be preconfigured to fly in a particular order or within a vertical 506 and horizontal space 507 to reduce the likelihood of collisions.

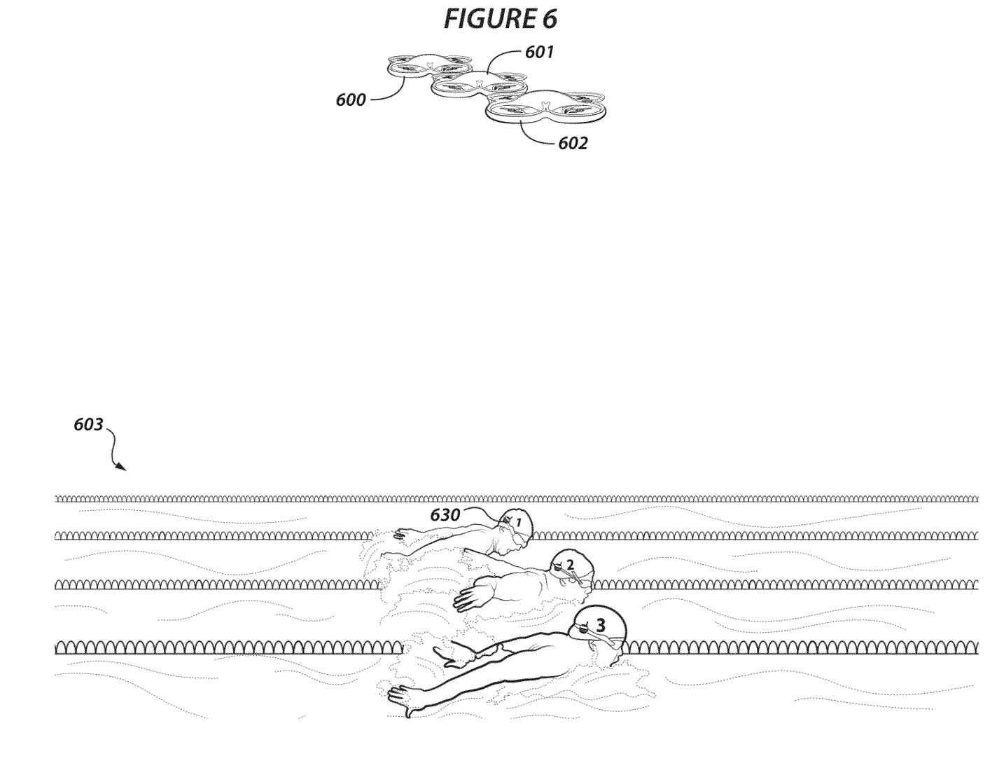

FIG. 6 is a simplified schematic diagram of a network of UAVs 600, 601, 602 in position to capture video, still images and other data of swimmers competing in a swim meet. In some embodiments, each UAV is coupled to an individual trackable system 630 suspended from the swimmers' head gear. In this embodiment, trackable system 630 includes a light weight waterproof trackable system which can communicate with one of the UAVs 600, 601, 602 or UAV control system. The network of UAVs 600, 601, 602 may operate next to each other according to the implementations described above with regards to FIG. 5.

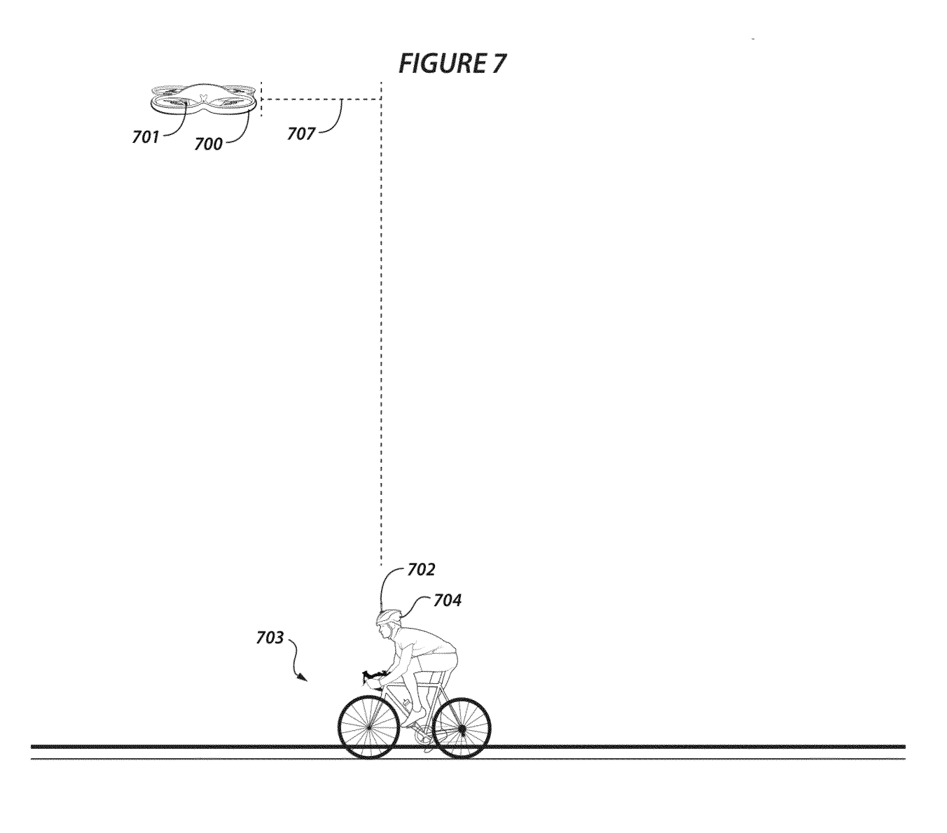

FIG. 7 is a simplified schematic diagram of a UAV 700 in position to capture video, still images and other data such as cadence, speed, acceleration, altitude, etc. of a biker. UAV 700 is flying above and in front (horizontal distance 707) the biker's bike 703 while in possession of a trackable system 702 consistent with the present disclosure. In the embodiment shown, the trackable system 702 is coupled to the biker's helmet 704. In some implementations, UAV 700 has a trackable system mounted thereto as well.

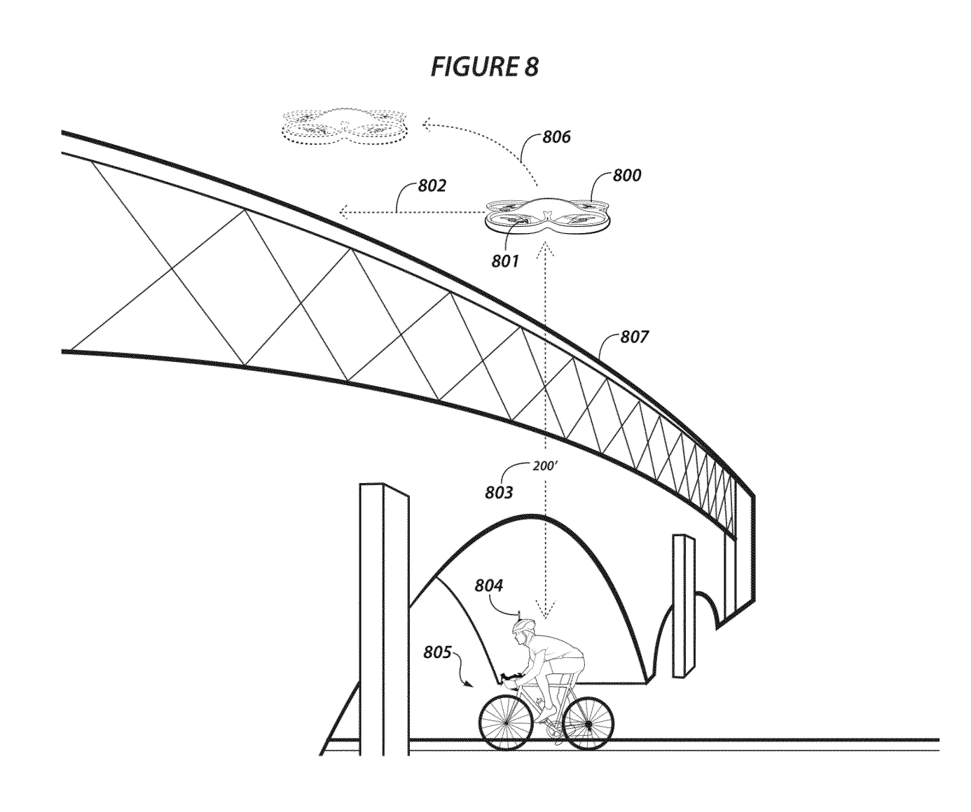

FIG. 8 is a simplified schematic diagram of a UAV 800 changing its vertical position while following and capturing video, still images, and other data of the biker. Advantageously, UAV 800 may change its altitude at specific GPS locations.

Specifically, UAV 800 may use geological and highway data such as, but not limited to, tunnels, bridges, and the like (e.g., geo data) or pre-race recorded data from a manually flown UAV 800 to avoid collisions and signal interferences. For example, UAV 800 may be programmed to change its altitude to fly above landmarks such as bridge 807, according to a preprogrammed vertical offset or displacement 806s from vertical obstructions for a pre-determined time or horizontal distance 802.

For instance, UAV 800 may change its vertical position a predetermined height (e.g., such as 25 feet for each vertical obstruction). Likewise, UAV 800 may change its horizontal position a predetermined distance for each horizontal obstruction. In addition, UAV 800 may maintain a predetermined height above trackable device 804 for a length of time for the UAV 800 to pass all vertical obstructions.

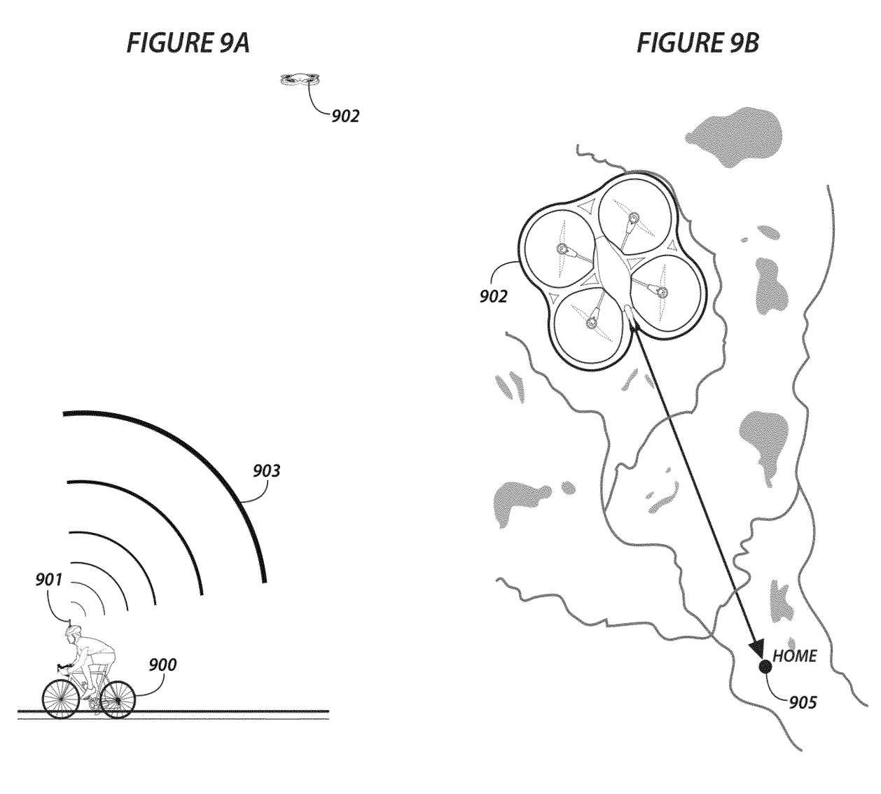

FIG. 9A is a simplified schematic diagram of a UAV 902 that is out of reach, communicatively, with a trackable system 901. As should be understood by those having ordinary skill in the art, when UAV 902 cannot detect signals 903 from trackable system 901, UAV 902 cannot effectively follow the biker. In some embodiments, when the UAV 902 cannot communicate with trackable system 901, UAV 902 returns to a pre-programmed location (e.g., home). Alternatively, UAV 902 may send alerts to a UAV monitoring station that it lost the trackable system 901 which in turn may issue commands to the UAV 902 to fly to a specific location.

FIG. 9B is a simplified schematic diagram of a UAV 902 that is heading to a home base 905 previously programmed into the UAV 902. Accordingly, in the event that UAV 902 is unable to receive signals from the trackable system, the UAV 902 returns to home base 905.

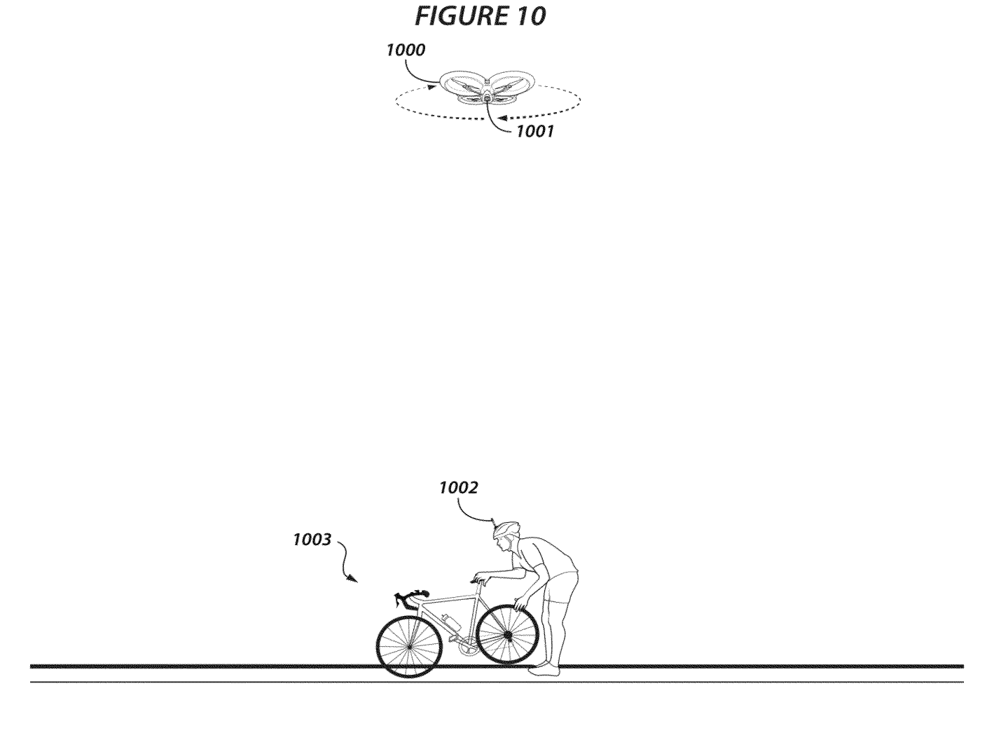

FIG. 10 is a simplified schematic diagram of an unmanned aerial vehicle 1000 hovering above a biker performing maintenance on a bike 1003. UAV 1000 may detect unusual data sets such as when a biker has stopped riding to perform maintenance on the bike 1003. An alert may be issued by UAV 100 to the biker's team or film crew to capture and broadcast the incident in real time. Alternatively, the UAV's camera 1001 component may record video or still images of the biker while the biker performs maintenance on the bike.

In some embodiments, a signal is transmitted to a monitoring station when UAV 1000 hovers over the trackable system 1002. For instance, if UAV 1000 fails to move a minimum vertical or horizontal distance within a predetermined time frame, or fails to move at a minimum speed an alert may be sent from the UAV to a UAV control system.

It should be understood by one having ordinary skill in the art that the present disclosure is not limited to sending alerts from the UAV device to a monitoring station when the trackable system is detected to be stationary (or other data condition for which an alert has been set or condition that is not normal as determined by the device itself from prior data sets). An alert may also be sent when the trackable system is detected to be traveling at speeds which exceed a predetermined threshold or when the trackable system 1002 is traveling off course so that key personnel can timely respond to these incidents.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A system, comprising:
an unmanned aerial vehicle, the unmanned aerial vehicle including a receiver to receive signals; and
a trackable system, the trackable system to transmit the signals to the unmanned aerial vehicle;
wherein the signals include location data which is to be used by the unmanned aerial vehicle to follow the trackable system.

2. The system of claim 1, wherein the trackable system includes a smartphone device.

3. The system of claim 1, wherein the trackable system is coupled to sporting equipment.

4. The system of claim 1 further comprising a monitoring station, the monitoring station is to be communicatively coupled to the unmanned aerial vehicle and the trackable system.

5. A method, comprising:
syncing an unmanned aerial vehicle to a trackable system such that the unmanned aerial vehicle receives location data from the trackable system;
transmitting the location data from the trackable system to the unmanned aerial vehicle;
utilizing the location data to cause the unmanned aerial vehicle to follow the trackable system; and
sending the location data to a monitoring station.

6. The method of claim 5 further comprising maintaining a predetermined vertical distance between the unmanned aerial vehicle and the trackable system.

7. The method of claim 5, wherein syncing the unmanned aerial vehicle to the trackable system includes configuring the unmanned aerial vehicle to receive wireless communications from the trackable system.

8. The method of claim 5, wherein a transmitter component of the trackable device transmits the location data to a receive component of the unmanned aerial vehicle.
